(19) United States
(12) Patent Application Publication
(10) Pub. No.: US 2007/0014460 A1
(43) Pub. Date: Jan. 18, 2007

(54) Method and apparatus for detecting various cell types of cells in a biological sample

(75) Inventors: Heiko Kuziela, Erlangen (DE); Thomas Wittenberg, Erlangen (DE); Robert Couronne, Erlangen (DE); Matthias Grobe, Nuernberg (DE); Christian Muenzenmayer, Nuernberg (DE)

Correspondence Address: BEYER WEAVER & THOMAS, LLP, P.O. BOX 70250, OAKLAND, CA, 94612-0250, US

(73) Assignee: Fraunhofer-Gesellschaft zur Foerderung der angewandten Forschung e.V.

(21) Appl. No.: 11/435,673

(22) Filed: May 16, 2006

Related U.S. Application Data
(63) Continuation of application No. PCT/EP04/12569, filed on Nov. 5, 2004.

(30) Foreign Application Priority Data
Nov. 18, 2003 (DE) 10353785.6-41

(51) Int. Cl. G06K 9/00

(52) U.S. Cl. 382/128

(57) ABSTRACT

In a method and an apparatus for detecting various cells types of cells in a biological sample, an image of the biological sample is provided. This image is normalized with regard to a distribution of the image values, and the normalized image is subsequently divided into a plurality of image sections. Each image section is associated with a predetermined class in dependence on predetermined properties of the image section. In each image section, the individual cells are detected, and features of these individual cells are determined. Subsequently, the individual cells are associated with a specific cell type on the basis of the features detected.

### CROSS-REFERENCE TO RELATED APPLICATIONS

This application is a continuation of copending International Application No. PCT/EP2004/012569, filed Nov. 5, 2004, which designated the United States, and was not published in English and is incorporated herein by reference in its entirety.

### BACKGROUND OF THE INVENTION

1. Field of the Invention

The present invention relates to a method and an apparatus for detecting various cell types of cells in a biological sample, and in particular to a method and an apparatus for automatic preparation of a differential blood picture, or blood count, on the basis of digitalized micrographs of blood smears using image-processing methods.

2. Description of Prior Art

For almost any patient admitted to hospital, a blood sample is taken which is to be used for diagnosing the patient. Depending on the assumed diagnosis, the doctor in charge calls for different blood testing methods to be performed. Such a blood test is represented by the so-called differential blood count. By means of the differential blood count, different causes of a given disease, such as inflammations, infections, allergic reactions, HIV, leukemia, etc. may be diagnosed.

The basis used for diagnosis here is the differential blood count, which indicates precisely the amount of times that microscope is a work which is tedious for the skilled person and which may also have effects on the health which may be attributed to working at the microscope.

In addition to the above-mentioned creation of a differential blood count, similar steps, to be precise an initial automated sample examination combined with a subsequent manual examination of unusual samples, are known also in other areas, such as, for example, in examining other human cells, above all in locating and classifying and/or detecting dysplastic (tumor-type preliminary stages) cells of the cervix (neck of the uterus) in women, and other diagnostic procedures based on cell analysis.

### SUMMARY OF THE INVENTION

Starting from this prior art, it is the object of the present invention to provide an improved method and an improved apparatus for detecting different cell types of cells in a biological sample, which, on the basis of a recording of a sample classified, e.g., as unusual, performs an evaluation of same and outputs the different cell types and their frequencies of occurrence in the sample without requiring any further manual steps to be performed by a skilled person.

In accordance with a first aspect, the invention provides a method of detecting various cell types of cells in a biological sample, the method including the steps of:
(a) providing an image of the biological sample;
(b) normalizing the image of the biological sample with regard to a distribution of image values in the image, so as to obtain a normalized image; specific subgroups of leucocytes (white blood cells) occur in the blood. Varying results which deviate from normal distribution allow conclusions to be made as to the respective causes. The evaluation, i.e. the counting of subgroups of the leucocytes, has for a long time been conducted manually under the microscope by a skilled person. In order to facilitate this tedious work, so-called automatic blood-picture machines have been gradually developed which take on this counting.

The prior art in the area of automated blood-picture machines is limited to automatic machines based on a chemical-physical principle. In accordance with this principle, a blood sample is diluted, by means of a liquid-based method, to such a degree that only one cell, respectively, is drawn through a stem. During the passage through this stem, characteristic information is obtained from each cell, the characteristic information allowing to associated the cell with a specific subgroup. Over the years, flow-through cytometry has proven effective in preparing an automatic differential blood count, and has become established in the laboratories of many hospitals and clinics. Most of these automatic flow-through cytometric machines allow to prepare differential blood counts of normal and unusual blood samples in a robust and reproducible manner.

In addition to the normal blood counts, however, above all time consuming blood counts which have been altered by various physiological and biological processes and which cannot be analyzed with sufficient precision by the automatic flow-through cytometric machines mentioned occur in hospitals. As a rule, such a sample is classified as unusual by such a known automatic machine, and the slide is examined manually under the microscope by a skilled person. The order of magnitude for the samples to be examined manually here is about 50% of samples fed to the automatic machines. Manual counting of the leucocytes under the
(c) dividing the normalized image into a plurality of image sections;
(d) associating each image section of the plurality of image sections with a predetermined class, depending on specific properties of the respective image section;
(e) detecting the individual cells or the cell group by combining image sections of the same class;
(f) detecting predetermined features from the individual cells or the cell groups; and
(g) associating the individual cells with various cell types on the basis of the features detected.

In step (e), e.g. the leucocyte plasma and the nucleus of white blood cells is combined into an individual cell referred to as “white blood cell”, or into a cell group referred to as “white blood cells”. Alternatively or additionally, the plasmas and the nuclei of red blood cells are combined into the individual cell referred to as “red blood cell”, or into the cell area referred to as “red blood cells”. What is background will remain (non-interesting) background.

Subsequently to step (e), provision may be made, in accordance with an embodiment, for detecting individual cells from the cell groups, e.g. by dividing the cell group into groups of image sections. If the combined area is too large (or is subject to other criteria), it is assumed that what is dealt with is a group of cells which touch each other, and this area will then be separated into individual cells.

In accordance with a preferred embodiment of the present invention, the image is generated by means of multi-channel picture-taking, the channels containing varying color information or other multi-spectral information. If the channels contain color information, this may be information relating to the color of the image, relating to the luminance and chrominance of the image, or relating to the hue, the saturation and the value of the image. The multi-spectral information may be based on pictures taken by means of IR rays, UV rays and X-rays.

In accordance with a further embodiment, provision is made—for the event that the channels contain varying color information—that in step (b), a color information value be detected for each channel for each image section, that a mean value be formed for each channel on the basis of the color information values detected, and that the image section be associated with the class on the basis of the mean value determined for each channel. In addition, provision may be made for the classification and/or association of an image detail with a class to be verified on the basis of one or several image sections surrounding the image section in question.

Preferably, the image is provided as a digital image, and the division is performed by specifying the image sections on the basis of a predetermined number of pixels. In addition, the chromaticity (RGB) of the image are preferably used for association with the classes.

In accordance with a further preferred embodiment of the present invention, normalization of the image is conducted prior to subdividing and/or sectioning the image into the image sections on the basis of a statistical distribution of various image values in the image, these preferably being color information of the image. In this case, summation is performed on the basis of a histogram of the color information. In accordance with a preferred embodiment, for an associated piece of color information, each channel has at least two maxima and one minimum, enclosed by same, associated with it at predetermined locations, respectively. Normalization is performed such that initially the maxima and the minimum contained in the histogram of a color channel of the image are calculated with regard to their locations, and that subsequently, the locations calculated are shifted to those locations associated with the channel contemplated. Color information between the extreme values are obtained by performing an interpolation between the maxima and the minimum. With digital pictures of blood cells, one obtains a “typical” histogram with two distinct maxima, and, therefore, one minimum therebetween.

In a further preferred embodiment, the inventive method additionally includes, prior to the step of detecting the individual cells, combining individual image sections into specific classes so as to specify respective image areas. In addition, the inventive method may preferably include the additional steps of determining the number of individual cells per cell type, and of outputting this number.

In accordance with a second aspect, the present invention further provides an apparatus for detecting various cell types of cells in a biological sample, having:

an input for receiving an image of the biological sample;

a signal processing means adapted to receive the image, present in the input, of the biological sample, to normalize the image received with regard to a distribution of the image values, to divide the normalized image into a plurality of image sections, to associate the image data with respectively predetermined classes in dependence on predetermined properties, to detect individual cells in the image sections, to determine predetermined features of the individual cells, and to associate the individual cells with various cell types, on the basis of the features determined and of the class of the associated image section in which the individual cell was contained; and

an output for providing the cell types specified by the signal processing means.

In accordance with a preferred embodiment, the apparatus further includes a sample input for receiving the biological sample, and a microscope having an associated digital camera, e.g. a CDD camera, for generating a digital image of the biological sample and of a detail of same. The signal processing means, for example a personal computer, is further adapted to receive the digital image and to process it accordingly.

In accordance with the present invention, a system is thus provided which “mimics” the procedure adopted by the skilled person required in the prior art, and takes on analysing the sample under the microscope by means of digital image processing, and automatically classifies and counts the cells.

In accordance with a preferred embodiment of the present invention, for pixel-block classification, the entire image is divided into blocks—in the preferred embodiment, in blocks sized 8×8 pixels. These blocks are preferably non-overlapping, the advantage of which being the higher processing speed which may thereby be achieved, since eventually, fewer pixels are contemplated. In addition, the method obtains a certain noise stability (so-called “pixel noise” caused by the digital camera, the signals of which always vary slightly, even when the scene recording remains absolutely the same). All in all, this reduction of the resolution of the image is acceptable, since the magnification of the microscope, and the physical pixel resolution of the camera are large enough to be able to recognize the essential structures (blood cells, white and red) even in blocks sized 8×8 pixels (a relevant object contains several such pixel blocks). For cases wherein an even more precise determination of the edges of the cells is required, the method may be repeated in the original magnification at the boundary of two blocks classified differently (e.g. “background”/“leucocyte plasma”) so as to make a finer distinction even within the 8×8 blocks. This approach using the various resolutions is also referred to as “hierarchical approach” in image processing. In principle, however, grouping into blocks sized 8×8 pixels is sufficient.

For each of the 8×8 blocks, the mean chromaticity is calculated from the present color channels, in the preferred embodiment RGB, and by means of said mean chromaticity, each block is classified into the necessary classes, in the preferred embodiment of the blood cells, “background”, “leucocyte plasma”, “leucocyte nucleus”, “erythrocyte plasma”.

In accordance with the invention, multiple classification is thus performed: initially, pixel blocks are classified, into background and parts of objects, as it were, the relevant objects (plasma plus nucleus of the white blood cells) are segmented thereafter (combining pixel blocks, and if need be, re-division if the cells touch), subsequently, characteristics thereof are calculated (e.g. size, shape, color of the objects=cells, surface area, circumference, roundness, granulation and/or texturing—of the cell nucleus and plasma, respectively), and, subsequently, these are again classified into the cell types of the leucocytes predefined by medicine. Their numbers of occurrence are counted and presented as a histogram (e.g. “13 leucocytes of the promyelocyte type, 42 of type . . . ”). However, no diagnosis is made. A printout is made depicting a histogram which shows the number of times that certain cell types of the leucocytes come up (in terms of percentage).

In addition to the above-described “white” blood count, there are further “blood counts” which may be prepared, e.g. “the red blood count”, “the complete blood count”, etc.

### BRIEF DESCRIPTION OF THE DRAWINGS

These and other objects and features of the present invention will become clear from the following description taken in conjunction with the accompanying drawing, in which:

FIGS. 1A to 1C show a block diagram which explains in more detail the inventive apparatus and the inventive method using a preferred embodiment relating to an automatic differential blood count machine;

FIG. 2 depicts the individual steps of pixel-block classification in accordance with a preferred embodiment of the present invention; and

FIG. 3 depicts the steps of color normalization in accordance with a preferred embodiment of the present invention.

### DESCRIPTION OF PREFERRED EMBODIMENTS

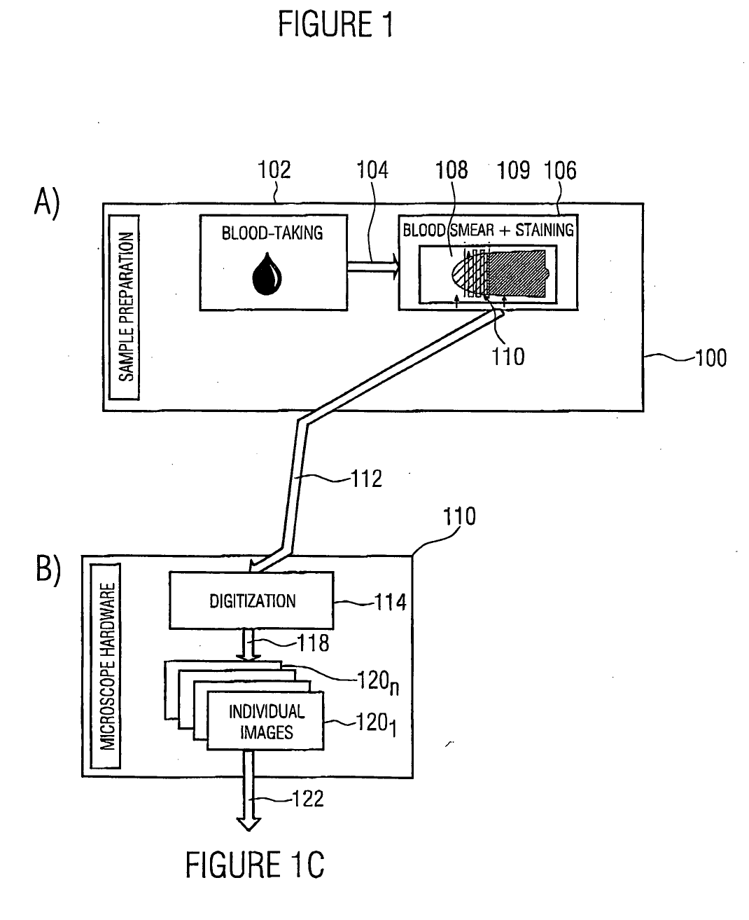

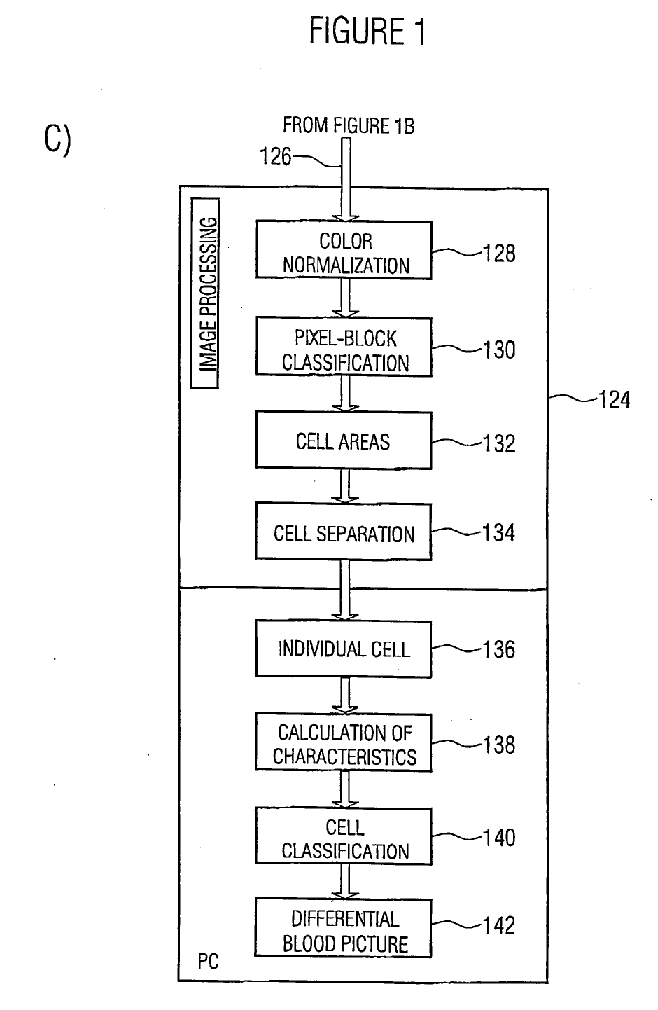

In FIG. 1, the inventive apparatus and the inventive method will be explained in more detail below using a schematic representation and using the example of an automatic differential blood count machine.

FIG. 1A shows a first portion 100 for sample separation. Here, the biological sample, a blood sample, is prepared using measures known per se. Sample preparation 100 includes blood-taking 102. As is illustrated by arrow 104, the blood taken is provided to further processing 106, in accordance with which a blood smear is performed, and same is stained. Thus, the sample preparation includes, for example, smearing out 106 the venous blood on a slide 108, as well as subsequently staining the slide 108, for example using the known May-Giemsa staining. Blood sample 109, which has been smeared out and stained, is schematically shown on slide 108.

FIG. 1B is a schematic representation of the microscope hardware 110 which is used in accordance with the invention and which receives the smeared-out and stained blood on the slide 108, as is schematically indicated by arrow 112. The hardware of microscope 110 includes an adjustable X-Y stage, not shown in any detail, on which slide 108 is arranged, controllable optics and illumination as well as a CCD color camera comprising a frame grabber. Slide 108 arranged on the adjustable X-Y stage is shifted under the microscope by means of same so as to digitize 114 the blood sample arranged on slide 108.

The blood sample 109 is digitized 114 such that the object is guided past the blood sample 109 in a meander-shaped manner, as is schematically shown at 116 in FIG. 1A. This passage is indeed achieved in that the slide 108 comprising the blood sample 109 arranged thereon is moved past the objective by means of the adjustable X-Y stage. As a rule, different parts of blood sample 109 are digitized, respectively, during digitization, and, as is schematically depicted by arrow 118, a plurality of individual images 120₁ to 120ₙ are output. In the event that the blood sample 109 is very small, digitization may also be conducted in one pass, and only one individual image may be output. As is schematically represented by arrow 122, the one individual image or the several individual images 120₁ to 120ₙ are provided at the output of microscope hardware 110 for further processing.

The inventive signal processing means and/or image processing means implemented, for example, in a computer, will be described below in more detail with reference to FIG. 1C. Computer 124 has the image processing implemented therein, which successively receives, at an input 126, the individual image or a plurality of the individual images 120₁ to 120ₙ provided by microscope hardware 110.

Image processing consists of the substeps of color normalization, pixel-block classification, cell-group formation, cell separation, provision of the individual cells, calculation of characteristics, cell classification and outputting of the differential blood count.

Color normalization 128 is provided to ensure that differently stained samples 109 are normalized to a “standard sample” with a defined color distribution and, if need be, defined illumination. Subsequent pixel-block classification 130 serves to combine several pixels of the image into one block and to associates these blocks with one or several classes. In connection with the preferred embodiment with regard to the differential blood count analysis, preferred and potential classes are the background or white blood cells. In succession to the pixel-block classification, the blocks are associated with specific cell groups 132, which is followed by a cell separation 134 so as to reliably separate all cells, since it may well occur for some cells to be arranged in an overlapping manner or to abut on one another. Subsequently to cell separation 134, only the individual cells 136 are now present as an intermediate result. For each individual cell 136, a feature calculation 138 is conducted so as to obtain, from the individual cells present, respective features characteristic for individual cell types. This is followed by a cell classification 140, in accordance with which a decision is made, using the features obtained, as to which cell type the individual cell belongs. All results of the cell classification 140 of the entire sample, i.e. of all processed individual images 120₁ to 120ₙ, form the differential blood count 142 which is output at the end.

The individual portions, which have just been described, as an overview, with reference to FIG. 1C, of the inventive approach for detecting cell types in a biological sample will be explained in more detail below.

Color normalization 128 ensures that differently stained samples 109 are normalized to a “standard sample” with a defined color distribution and, if need be, a defined illumination.

For the subsequent pixel-block classification 130, it is necessary that the images 120₁ to 120ₙ received at the input 126 comprise a specific and invariably identical color distribution so as to ensure that the classification of the individual blocks may be performed correctly. Conventional methods have used techniques such as the color calibration of cameras to ensure stable and consistent recording of the images. The disadvantage of said approach is that it is static and is calculated only once. These techniques are thus inflexible, in particular when a change occurs in the staining of the sample material. In this case, the known color calibration no longer matches the situation and must be re-calculated. The disadvantage is obvious, since this is time-consuming and may require, as the case may be, additional user interaction, which is not feasible for an automatic system as is strived for in accordance with the invention.

The inventive method circumvents this weakness known from literature in that each image 120₁ to 120ₙ is treated individually and is adjusted to a known and predefined color distribution. This ensures that changes in the staining and in the picture-recording technique may be balanced in a simple and precise manner.

In accordance with a preferred embodiment of the present invention, a histogram adjustment based on the chromaticities of the individual images 120₁ to 120ₙ received is conducted for normalizing the stained blood smears 109. A color histogram based on the red channel, the green channel, and the blue channel of the digital camera exhibits, for a typical detail of a digitized blood smear, two characteristic maxima and one minimum, enclosed by these two maxima, in each color channel (RGB). The locations at which these extreme locations crop up are different for each channel. To achieve normalization of a color image in this sense, for each color channel of the image, the locations of the extremes must be calculated and provided to the method. Once these locations are known for all color channels, the histogram may be re-calculated for each image and each color channel. To this end, the locations measured in the actual image for a color channel are shifted to the locations which have been pre-specified and defined for this channel, and values in the histogram which are located between the three extremes are interpolated in a linear manner. This is performed for each channel, so that what results is a normalized image with known and defined color distribution.

In the pixel-block classification 130, several pixels in the digital image received are combined into one block, and the respective block is associated with one class. In the preferred embodiment, the possible classes are the background, red blood cells (erythrocyte), white blood cells (leucocyte), and the nucleus of the white blood cell. Generally, this method may also be utilized for other classes and other problems, this entailing a need to perform an adequate adjustment of the color distribution in the color normalization step 128.

In accordance with a preferred embodiment, a digitized color image 120₁ to 120ₙ of a blood smear 109 is divided into blocks sized 8×8 pixels. For each block, the mean chromaticity per channel (R,G,B) is calculated. The three mean values thus obtained are supplied to a classifier which associates the respective blocks to one of the four above-mentioned classes on the basis of the three mean values. In accordance with a preferred embodiment, a verification step is provided so as to avoid any erroneous classifications of a block. Any erroneous classifications of a block are identified by a comparison with the surroundings of the block, and are corrected, so that the inventive method is more robust against variations in illumination.

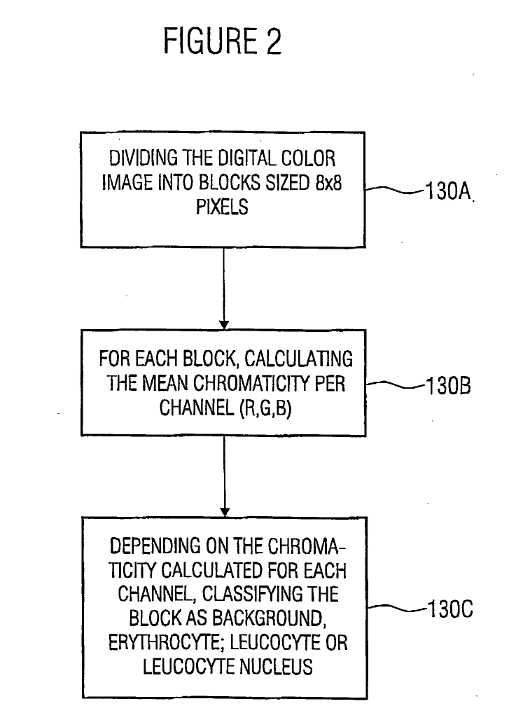

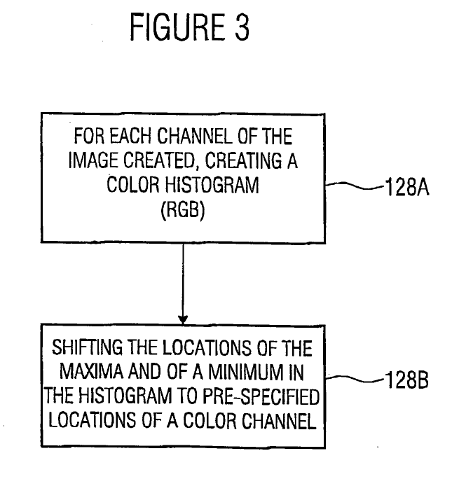

FIGS. 2 and 3 show again the main steps of color normalization 128 and of pixel-block classification 130 which have just been described. FIG. 2 again depicts the individual steps of the pixel-block classification, wherein step 130a here includes, as has been mentioned, dividing the digital color image into blocks sized 8×8 pixels. In block 130b, for each block, the mean chromaticity per channel is calculated, and subsequently, at 130c, the block is classified as background, erythrocyte, leucocyte or leucocyte nucleus, depending on the chromaticity calculated for each channel. FIG. 3 again depicts the two main steps of color normalization 128, with a color histogram being initially generated, in accordance with 128a, for each channel of the image created, and subsequently, at 128b, the locations of the maxima and of the minimum in the histogram are shifted to pre-specified locations of a color channel.

In succession to the pixel-block classification 130, a cell group specification 132 is performed, wherein the classified blocks are combined, in accordance with the preferred embodiment, into two classes. The first class is referred to as “background”, and includes those blocks which have been classified as background or as red blood cells in step 130. The second class is the class of “white blood cells”, and includes those blocks which have been classified as white blood cells or nuclei of the white blood cells in the preceding step 130. This information is present in the form of a binary image provided to the subsequent cell separation. Depending on the type of the cell types to be detected, only individual, or all, of the classified blocks may be supplied to further processing. In the event of the evaluation of the sample with regard to the white blood cells, it is sufficient to use only those blocks which have been classified as “white blood cell” and “nucleus of a white blood cell”, these being associated in advance with a common cell group.

The step of cell separation 134 includes separating all cells, since it may occur that some cells abut on one another or overlap. To ensure that even cells which touch each other, i.e. individual cells, are recognized, cell separation must be performed. To this end, the binary image of step 132 is treated using distance transformation which is known in the prior art. Subsequently to this transformation, it is possible to apply the known so-called watershed transform, which is able to cut several cells, which touch each other, at the line of contact. After the cell separation, a cohesion analysis of the primary image is performed to localize the individual cells. Such transformations are mentioned, for example, in the publications cited below.

“Applying watershed algorithms to the segmentation of clustered nuclei: Defining strategies for nuclei and background”, Malpica N., Ortiz de Solórzano C., Vaquero J. J., Santos A., Vallcorba I. García-Sagredo J. M., del Pozo F. *Cytometry* 28: pages 289-297 1997, ISSN 0196-4763.

“Watershed, hierarchical segmentation and waterfall algorithm” in Mathematical Morphology and its Applications to Image Processing, Beucher, S., J. Serra and P. Soille, Eds. Kluwer Acad. Publ., Dordrecht, 1994, pages 69-76.

“Eine Erweiterung der Wasserscheiden-Transformation fur die Farbbildsegmentierung (An Extension of the Watershed-Transform for Color Image Segmentation)” In Proc. 6th German Workshop on Color Image Processing”, A. Koschan and T. Harms, G. Stanke, M. Pochanke, Eds., Berlin, ISBN 3-9807029-4-4, pages 5-12, October 2000.

The individual cells 136 present as a result are supplied to feature calculation 138 so as to detect predetermined features characteristic for individual cell types, so as to subsequently specify, at 140, respective cell types for the individual cell on the basis of the so-called features, or characteristics.

All results of the cell classification of the entire sample form the differential blood count 142, the number of cells per cell type here preferably being presented to the user in a manner which can easily be understood in medical terms. Here, in accordance with the preferred embodiment, only cell types are counted, i.e. a kind of measuring system is implemented. It is up to a competent doctor to interpret these results.

Even though preferred embodiments which use a color image as a 3-channel image have been described above with reference to the figures, the present invention is not limited thereto. Instead of the RGB values for characterizing the color image, information relating to the luminance and chrominance, L*u*v*, or information relating to the hue (H) of the saturation (S) and of the value (V) of the image may be used as the basis. The color image data may thus also be described in the HSV color space or in the L*u*v* color space. To this end, the RGB data obtained may be converted into the respective color spaces. The RGB data may also be transferred into other known color spaces.

In addition, the present invention is not limited to taking a 3-channel picture, and the image may be generated by an n-channel, n≧2 recording. In addition to the color data, the channels may also include other multi-spectral data/information, such as information based on the IR rays, UV rays and X-rays, etc.

In addition, it is to be noted, with regard to the above-described preferred embodiment, that the steps described there in connection with the color normalization and the pixel-block classification may also be used on their own, respectively, in detecting other cell types. In addition, the above-described color normalization may also be employed in separately from the remaining steps, in other classification techniques, wherein provision of images with consistent color distribution is required. The same applies to pixel-block classification, which may also be used in other classification techniques irrespective of the above-described method steps.

Even though the preferred embodiment has been described with reference to the processing of one individual image, it is obvious that, depending on the circumstances, several images may be processed in sequence, if the sample is represented by a plurality of images, so as to ensure an analysis of the overall sample.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A method of detecting various cell types of cells in a biological sample, comprising:
(a) providing an image of the biological sample;
(b) normalizing the image of the biological sample with regard to a distribution of image values in the image, so as to obtain a normalized image;
(c) dividing the normalized image into a plurality of image sections;
(d) associating each image section of the plurality of image sections with a predetermined class, depending on specific properties of the respective image section;
(e) detecting the individual cells or the cell group by combining image sections of the same class;
(f) detecting predetermined features from the individual cells or the cell groups; and
(g) associating the individual cells with various cell types on the basis of the features detected.

2. The method as claimed in claim 1, wherein the image in step (a) is created by a multi-channel recording, the channels containing differing color information or other multi-spectral information, wherein, when the channels contain color information, information relating to the color RGB of the image, relating to the luminance and chrominance of the image or relating to the hue, the saturation and the value of the image is associated with the channels, and wherein the further multi-spectral information is based on recordings performed by IR rays, UV rays and X-rays.

3. The method as claimed in claim 2, wherein the channels contain differing color information, and wherein step (d) includes the following substeps for each image section:
(d.1) detecting color information values for each channel;
(d.2) forming a mean value for each channel on the basis of the color information values detected in step (d.1), and
(d.3) associating the image section with a class on the basis of the mean values determined for each channel.

4. The method as claimed in claim 1, wherein step (d) includes verifying an association of an image section with a class on the basis of one or several image sections surrounding the image section in question.

5. The method as claimed in claim 1, wherein a digital image is created in step (a), and wherein in step (c), a predetermined number of pixels are selected for specifying an image section.

6. The method as claimed in claim 1, wherein the property which has been used in step (d) for association with the classes includes chromaticities of the image.

7. The method as claimed in claim 1, wherein in step (b), the image is normalized on the basis of a statistical distribution of the various image values in the image.

8. The method as claimed in claim 7, wherein the image values include color information for the image, and wherein the normalization is based on a histogram of the color information.

9. The method as claimed in claim 8, wherein each channel includes, for an associated piece of color information, at least two maxima of the color information and one minimum, enclosed by same, of the color information at predetermined locations, and wherein step (b) includes the following substeps for each channel:
(b.1) calculating the locations of the maxima and of the minimum in the image, and
(b.2) shifting the locations calculated in step (b.1) to the locations associated with the channel contemplated.

10. The method as claimed in claim 9, wherein color information between the shifted locations were determined by interpolation between the maxima and the minimum.

11. The method as claimed in claim 1, wherein prior to step (e), the image sections are combined into specific classes so as to specify respective image areas.

12. The method as claimed in claim 1, comprising the following step after step (e)
detecting individual cells from the cell groups specified in step (e).

13. The method as claimed in claim 1, comprising:
(a) determining the number of individual cells per cell type; and
(b) outputting the number.

14. An apparatus for detecting various cell types of cells in a biological sample, comprising:
an input for receiving an image of the biological sample;
a signal processor adapted to receive the image, present in the input, of the biological sample, to normalize the image received with regard to a distribution of the image values, to divide the normalized image into a plurality of image sections, to associate the image data with respectively predetermined classes in dependence on predetermined properties, to detect individual cells in the image sections, to determine predetermined features of the individual cells, and to associate the individual cells with various cell types, on the basis of the features determined and of the class of the associated image section in which the individual cell was contained; and
an output for providing the cell types specified by the signal processor.

15. The apparatus as claimed in claim 14, comprising
a sample input for receiving the biological sample; and
a microscope having an associated digital camera for generating a digital image of the biological sample or of a detail of same;
the signal processor being adjusted to receive the digital image.
